(19) United States
(12) Patent Application Publication
(10) Pub. No.: US 2020/0387792 A1
(43) Pub. Date: Dec. 10, 2020

(54) LEARNING DEVICE AND LEARNING METHOD

(71) Applicant: Mitsubishi Electric Corporation, Tokyo (JP)

(72) Inventor: Tomoya FUJINO, Tokyo (JP)

(73) Assignee: Mitsubishi Electric Corporation, Tokyo (JP)

(21) Appl. No.: 16/971,482

(22) PCT Filed: Mar. 16, 2018
(86) PCT No.: PCT/JP2018/010446

§ 371 Date: Aug. 20, 2020

(51) Int. Cl. G06N 3/08; G06N 3/063; G06K 9/62

(52) U.S. Cl. CPC G06N 3/08; G06N 3/063; G06K 9/6262; G06K 9/628; G06K 9/6256

(57) ABSTRACT

A learning unit learns a neural network by inputting elements of learning data, on the basis of a learning reference label obtained by assigning an OK label or an NG label to each of the elements of the learning data, and outputs a classifier for determining at least one piece of data belonging to an NG determination group to be NG. A dynamic update unit dynamically updates the learning reference label during learning of the neural network by the learning unit.

### TECHNICAL FIELD

The present invention relates to a learning device and a learning method for learning a classifier using a neural network.

### BACKGROUND ART

Generally, learning image data used for performing abnormality detection is determined to be normal (hereinafter referred to as OK) or abnormal (hereinafter referred to as NG) for each image.

Meanwhile, in learning image data determined to be NG, an image area including an NG element is often local, and most areas are not locally different from learning image data that is determined to be OK.

Known in the related art is machine learning that uses learning data including multiple elements in each of which is determined to be OK or NG.

For example, Patent Literature 1 discloses technology in which an input image is divided into multiple image areas, and a label for distinguishing between a foreground and a background is assigned to each of the divided image areas. In this technology, it is estimated whether a pixel to which an unconfirmed label has been assigned is a foreground or a background on the basis of continuity from an image area assigned with a confirmed label of the foreground or the background.

### CITATION LIST

### Patent Literature

Patent Literature 1: JP 2012-208913 A

### SUMMARY OF INVENTION

### Technical Problem

In a case where an image, a moving image, or multidimensional data is classified as OK or NG by machine learning, data determined to be OK or NG by a human is often provided as learning data. However, it is rare that all elements included in the learning data are NG, and in many cases determination as NG is made only from unspecified elements. Using such learning data results in erroneously learning an element that is originally OK as NG, and thus there is a disadvantage that the classification accuracy of a classifier, as a learning result, is deteriorated.

An object of the present invention is to solve the above disadvantage, and an object of the invention is to obtain a learning device and a learning method that can provide a classifier that performs highly accurate classification.

### Solution to Problem

A learning device according to the present invention includes a learning unit and a dynamic update unit. The learning unit inputs learning data including multiple elements and group information in which it is defined that at least one piece of data belonging to a group is determined to be NG, and learns a neural network by inputting the multiple elements of the learning data and using a learning reference label assigned with an OK label or an NG label for each of the elements of the learning data, thereby outputs a classifier for determining the at least one piece of data belonging to the group to be NG using the neural network which is a result of the learning. The dynamic update unit dynamically updates the learning reference label during the learning of the neural network by the learning unit. In this configuration, the learning unit generates an initial value of the learning reference label for each of the elements of the learning data by using the learning data and the group information, repetitively learns the neural network, by sequentially using the learning reference label updated from the initial value of the learning reference label by the dynamic update unit, and calculates an NG index value with which each of the elements of the learning data can be NG, by using an output value of the neural network for each repetition of learning. The dynamic update unit updates the learning reference label, on the basis of a result obtained by statistically testing a change trend of the NG index value obtained for each transition of the number of learning repetitions.

### Advantageous Effects of Invention

According to the present invention, the learning device can provide a classifier for performing high-precision classification by determining at least one piece of data belonging to a group to be NG.

### BRIEF DESCRIPTION OF DRAWINGS

FIG. 1 is a block diagram illustrating a configuration of a learning device according to a first embodiment of the invention.

FIG. 2 is a block diagrams illustrating a detailed configuration of a learning device according to the first embodiment.

FIG. 3 is a table illustrating an example of the contents of a learning data DB.

FIG. 4 is a table illustrating an example of the contents of an NG determination group DB.

FIG. 5 is a table illustrating an example of the contents of a learning reference label buffer.

FIG. 6 is a diagram illustrating an example of a configuration of a neural network.

FIG. 7 is a table illustrating an example of the contents of an NG index value buffer.

FIG. 8 is a table illustrating an example of the contents of a history buffer.

FIG. 9 is a table illustrating an example of the contents of an NG candidate buffer.

FIG. 10A is a block diagram illustrating a hardware configuration for implementing functions of the learning device according to the first embodiment. FIG. 10B is a block diagram illustrating a hardware configuration for executing software for implementing the functions of the learning device according to the first embodiment.

FIG. 11 is a flowchart illustrating a learning method according to the first embodiment.

FIG. 12 is a flowchart illustrating a learning reference label generating process.

FIG. 13 is a flowchart illustrating a neural network managing process.

FIG. 14 is a flowchart illustrating a history managing process of NG index values.

FIG. 15 is a flowchart illustrating a statistical test process of NG index values.

FIG. 16 is a flowchart illustrating a learning reference label updating process.

FIG. 17 is a flowchart illustrating a neural network parameter updating process.

### DESCRIPTION OF EMBODIMENTS

To describe the present invention further in detail, embodiments for carrying out the invention will be described below along with the accompanying drawings.

### First Embodiment

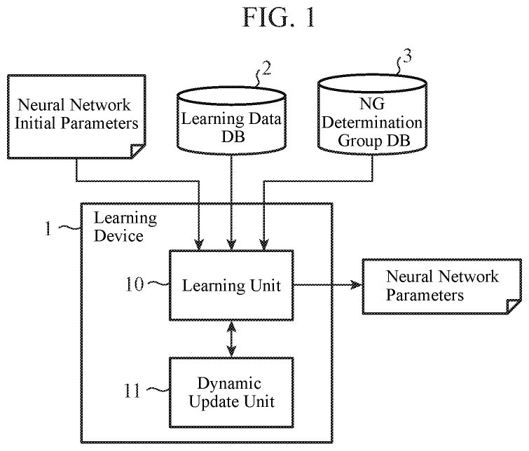

FIG. 1 is a block diagram illustrating a configuration of a learning device 1 according to a first embodiment of the invention.

The learning device 1 generates neural network parameters that provide a classifier of a learning result, by updating neural network initial parameters using learning data input from a learning data database (hereinafter referred to as the learning data DB) 2 and NG determination group information input from an NG determination group database (hereinafter referred to as the NG determination group DB) 3.

The learning data stored in the learning data DB 2 includes multiple elements. For example, in a case where the learning data is image data, individual image areas obtained by dividing an image indicated by the image data into multiple pieces are elements. In the NG determination group information stored in the NG determination group DB 3, it is defined that at least one piece of data belonging to an NG determination group is determined to be NG.

The learning device 1 includes a learning unit 10 and a dynamic update unit 11. The learning unit 10 inputs learning data from the learning data DB 2, inputs NG determination group information from the NG determination group DB 3, and learns a neural network by inputting multiple elements of the learning data and using a learning reference label for each of the elements of the learning data. A learning reference label is information in which an OK label or an NG label is assigned to each of the elements of the learning data. The learning unit 10 outputs neural network parameters that provide the classifier that determines at least one piece of the data belonging to the NG determination group to be NG.

The learning unit 10 further generates an initial value of a learning reference label for each of the elements of the learning data using the learning data and the NG determination group information, and repetitively learns the neural network by sequentially using a learning reference label that is dynamically updated from the initial value of the learning reference label by the dynamic update unit 11. The learning unit 10 calculates an index value with which an element of the learning data can be NG (hereinafter, referred to as an NG index value), by using an output value of the neural network for each repetition of learning.

The dynamic update unit 11 dynamically updates the learning reference label while the learning unit 10 learns the neural network. Specifically, the dynamic update unit 11 statistically tests the change trend of the NG index value obtained for each transition of the number of learning repetitions, and updates the learning reference label on the basis of the statistical test result. The dynamic update unit 11 updates an NG label, assigned to an element that is originally OK in the learning reference label, to an OK label by using the statistical test result of the change trend of NG index values.

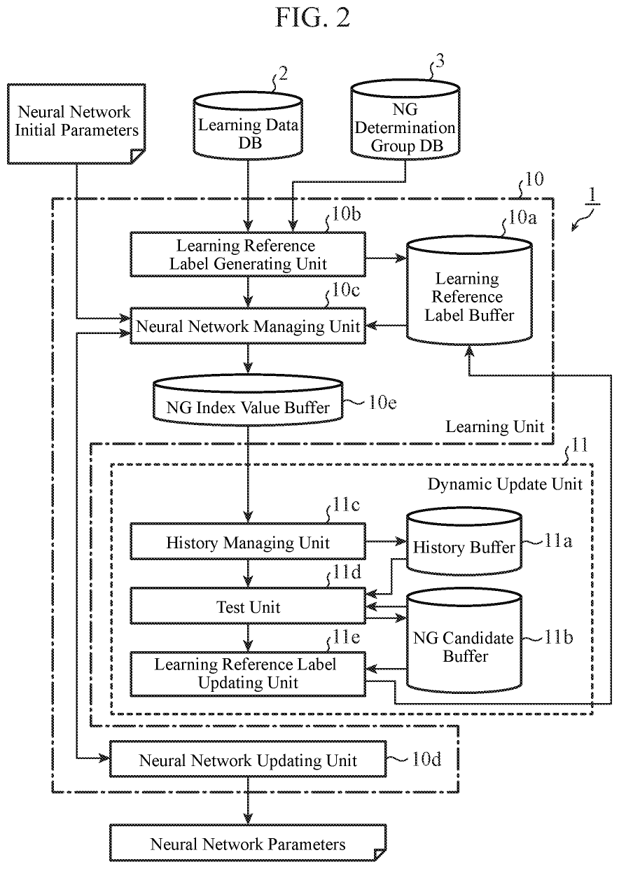

FIG. 2 is a block diagram illustrating a detailed configuration of the learning device 1 according to the first embodiment. As illustrated in FIG. 2, the learning unit 10 includes a learning reference label buffer 10a, a learning reference label generating unit 10b, a neural network managing unit 10c, a neural network updating unit 10d, and an NG index value buffer 10e. The dynamic update unit 11 includes a history buffer 11a, an NG candidate buffer 11b, a history managing unit 11c, a test unit 11d, and a learning reference label updating unit 11e.

Neural network initial parameters are parameters that define the initial state of the neural network. For example, the neural network initial parameters include initial values of the number of nodes of a hidden unit in the neural network, weight parameters assigned between nodes, bias parameters, and learning rate parameters. These parameters are described in Reference Literature 1 below. With the learning device 1 updating the neural network initial parameters, neural network parameters are generated which provide the classifier that determines at least one piece of data belonging to the NG determination group to be abnormal.

Reference Literature 1: C. M. Bishop, Hiroshi Motoda (supervising a translation), “Pattern Ninshiki To Kikai Gakusyu, Jyou”, Maruzen Publishing, pp. 225-247.

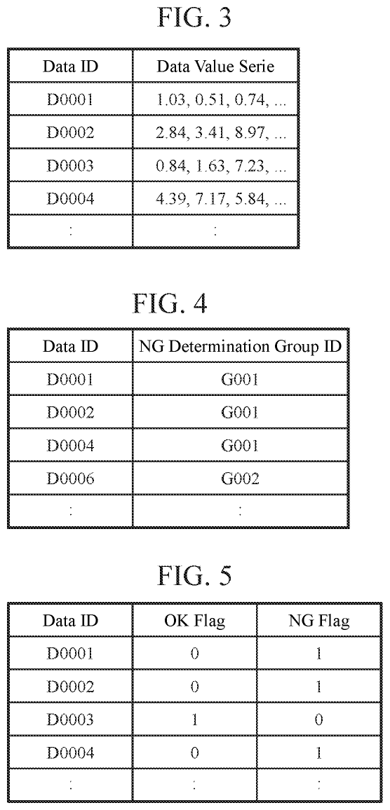

The learning data DB 2 stores learning data including multiple elements. FIG. 3 is a table illustrating an example of the contents of the learning data DB 2. In FIG. 3, learning data includes multiple elements identified by respective “data IDs”, and each of the multiple elements includes a “data value series”. For example, illustrated in FIG. 3 are an element having a data ID of D0001, an element having a data ID of D0002, an element having a data ID of D0003, an element having a data ID of D0004, . . . , which are included in certain learning data.

The NG determination group DB 3 stores NG determination group information including classification information of NG determination groups and classification information of elements of learning data belonging to the NG determination groups. FIG. 4 is a table illustrating an example of the contents of the NG determination group DB 3. Each of the multiple elements included in the learning data is classified by a “data ID” as in FIG. 3. An NG determination group is classified by an “NG determination group ID”. For example, an element having a data ID of D0001, an element having a data ID of D0002, and an element having a data ID of D0004 belong to an NG determination group having an NG determination group ID of G001, and at least one of these elements is determined to be NG.

The learning reference label buffer 10a stores a learning reference label for each element of the learning data. FIG. 5 is a table illustrating an example of the contents of the learning reference label buffer 10a. As illustrated in FIG. 5, learning reference label information includes data ID, OK flag, and NG flag of each of the elements of the learning data. Each of the multiple elements included in the learning data is classified by a “data ID” as in FIG. 3. For an element assigned with an OK label, value 1 is set in the OK flag corresponding to this element, and value 0 is set in the NG flag corresponding to this element. Conversely, for an element assigned with an NG label, value 0 is set in the OK flag corresponding to this element, and value 1 is set in the NG flag corresponding to this element.

The learning reference label generating unit 10b generates initial values of the learning reference label on the basis of a determination result as to whether or not the learning data belongs to the NG determination group. For example, the learning reference label generating unit 10b determines whether or not among the data IDs of the elements registered in the learning data DB 2, there is a data ID which is same as that of an element belonging to the NG determination group in the NG determination group DB 3. If it is determined that there is a same data ID as that of an element belonging to the NG determination group, the learning reference label generating unit 10b generates a learning reference label in which value 0 is set in the OK flag corresponding to this element and value 1 is set in the NG flag corresponding thereto, and stores the learning reference label in the learning reference label buffer 10a.

The neural network managing unit 10c manages learning of a neural network for sorting an element corresponding to a data ID stored in the learning data DB 2 to a class (OK class or NG class) that corresponds to a flag having a value of 1 among the OK flag and the NG flag that corresponds to the data ID in the learning reference label buffer 10a.

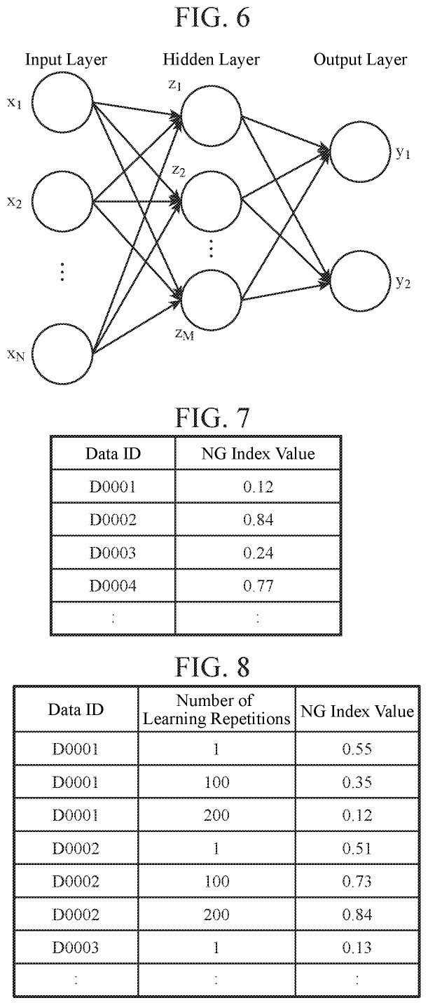

FIG. 6 is a diagram illustrating an example of a configuration of the neural network. As illustrated in FIG. 6, the neural network includes an input layer, a hidden layer, and an output layer. When a data value series x₁, x₂, . . . , x_{N} included in an element of learning data is input to the input layer, z₁, z₂, . . . , z_{M} are calculated by nonlinear transformation of the multiplication sum of weight parameters between the input layer nodes and the hidden layer nodes and x₁, x₂, . . . , x_{N}. Subsequently, y₁ and y₂ obtained by nonlinearly transforming the multiplication sum of weight parameters between the hidden layer nodes and the output layer nodes and z₁, z₂, . . . , z_{M} are output from the output layer.

The output values y₁ and y₂ are NG evaluation values for each class, with the output value y₁ representing the degree to which the element belongs to the OK class, and the output value y₂ representing the degree to which the element belongs to the NG class. An element (data value series) input to the neural network is determined to belong to the OK class when y₁>y₂ holds, and is determined to belong to the NG class when y₁≤y₂ holds. The NG index value may be a ratio between y₂ and y₁ corrected so that the denominator of the ratio is other than 0; however, hereinafter, y₂−y₁ will be the NG index value.

Note that although the neural network having one hidden layer is illustrated in FIG. 6, the neural network managed by the neural network managing unit 10c may have multiple hidden layers.

The neural network updating unit 10d outputs neural network parameters that provide a classifier of a learning result by updating neural network parameters on the basis of the NG index value obtained by the neural network managing unit 10c. For example, the neural network updating unit 10d updates neural network parameters using the parameter optimization method described in Reference Literature 1. When the number of repetitions of learning reaches a threshold value or when the condition for terminating the learning is satisfied, the neural network updating unit 10d outputs neural network parameters optimized and updated at that stage to the outside of the learning device 1.

The NG index value buffer 10e stores an NG index value for each element of the learning data obtained in the course of learning repetitions of the neural network. FIG. 7 is a table illustrating an example of the contents of the NG index value buffer 10e. A data ID of an element of the learning data, and an NG index value as of the time when calculated by the neural network managing unit 10c, out of NG index values of this element, are set in the NG index value buffer 10e.

The history buffer 11a stores the number of learning repetitions and an NG index value corresponding thereto for each element of the learning data. FIG. 8 is a table illustrating an example of the contents of the history buffer 11a. In the history buffer 11a, NG index values for the number of learning repetitions of 1, 100, and 200 are set. For example, for an element with a data ID of D0001, an NG index value obtained when the number of learning repetitions is 1 is 0.55, an NG index value obtained when the number of learning repetitions is 100 is 0.35, and an NG index value obtained when the number of learning repetitions is 200 is 0.12.

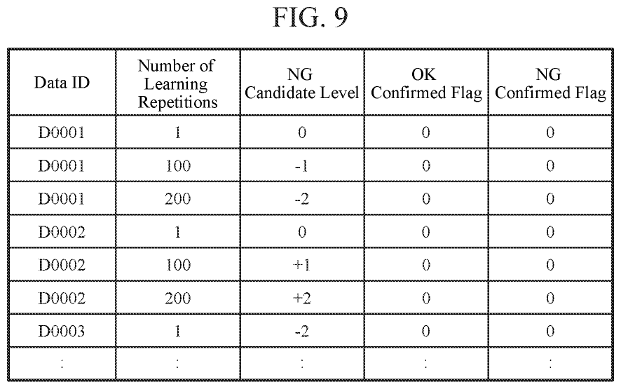

The NG candidate buffer 11b stores the number of learning repetitions, an NG candidate level, an OK confirmed flag, and an NG confirmed flag for each element of the learning data. FIG. 9 is a table illustrating an example of the contents of the NG candidate buffer 11b. As illustrated in FIG. 9, data IDs of elements of the learning data, NG candidate levels, OK confirmed flags, and the NG confirmed flags are set in the NG candidate buffer 11b. The NG candidate level varies depending on a past value of the NG index value.

An NG candidate is an element assigned with an NG label in the learning reference label, and an NG candidate level corresponds to an NG index value that corresponds to the element of the NG candidate.

An OK confirmed flag indicates that an element is confirmed to be OK. For example, if value 0 is set in the OK confirmed flag, it indicates that the element corresponding to the OK confirmed flag is not confirmed to be OK, and if value 1 is set, it indicates that the element corresponding to the OK confirmed flag is confirmed to be OK. On the other hand, an NG confirmed flag indicates that an element is confirmed to be NG. For example, if value 0 is set in the NG confirmed flag, it indicates that the element corresponding to the NG confirmed flag is not confirmed to be NG, and if value 1 is set, it indicates that the element corresponding to the NG confirmed flag is confirmed to be NG.

The history managing unit 11c stores, in the history buffer 11a, an NG index value for each element of the learning data, obtained for each repetition of learning. For example, the history managing unit 11c stores, in the history buffer 11a, an NG index value stored in the NG index value buffer 10e together with the number of learning repetitions at that time. As a result, an NG index value obtained at each preset number of learning repetitions (in the example of FIG. 8, one time, 100 times, and 200 times) is stored in the history buffer 11a.

The test unit 11d statistically tests the change trend of NG index values stored in the history buffer 11a, and updates the contents of the NG candidate buffer 11b for each element of the learning data on the basis of the statistical test result. For example, the test unit 11d extracts, from the history buffer 11a, a time series of NG index values for respective transitions of the number of learning repetitions that corresponds to the element to be processed. Next, the test unit 11d statistically tests the time series of the NG index values extracted from the history buffer 11a to confirm the change trend of the NG index values.

The test unit 11d performs an irregularity test on the time series of the NG index values. In a case where by the irregularity test it is confirmed that there is no regularity in the change of the NG index values, the test unit 11d leaves this element as the NG candidate. In a case where it is confirmed that there is regularity, the test unit 11d performs a trend test on the time series of the NG index values. If by the trend test it is confirmed that the NG index values have an upward trend, the test unit 11d leaves this element as the NG candidate.

When the time series of the NG index values has regularity and an upward trend thereof is confirmed, the test unit 11d determines this element to be NG-confirmed, and sets value 1 to the NG confirmed flag corresponding to this element in the NG candidate buffer 11b. On the other hand, when the time series of the NG index values has regularity and a downward trend thereof is confirmed, the test unit 11d determines this element to be OK-confirmed, and sets value 1 to the OK confirmed flag corresponding to this element in the NG candidate buffer 11b.

As methods of testing the irregularity and the trend, test methods described in Reference Literature 2 below may be used.

Reference Literature 2: Shinsuke Muto, “Toukei Kaiseki Handbook”, Asakura Publishing Co. Ltd., pp. 398-399 and 402-403.

The learning reference label updating unit 11e updates the learning reference label of an element of the learning data that is confirmed to be OK by the test unit 11d, from the NG label to the OK label. For example, when an element of the learning data is confirmed to be OK by the test unit 11d, the learning reference label updating unit 11e sets value 1 to the OK flag in the learning reference label corresponding to this element, and sets value 0 to the NG flag.

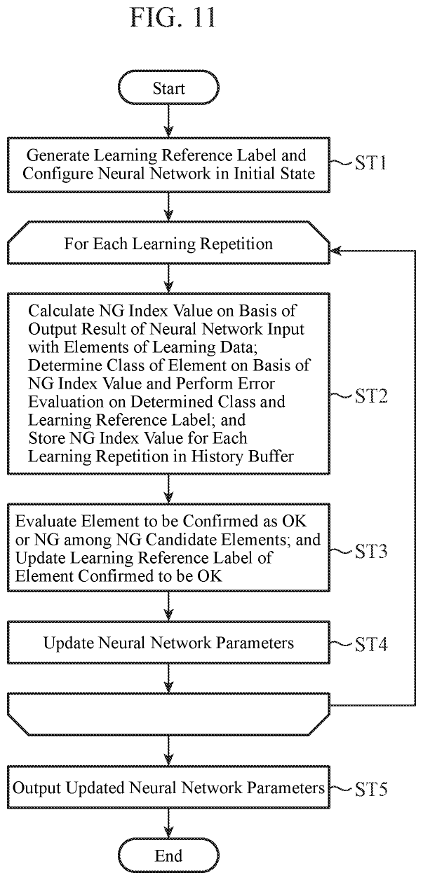

The functions of the learning unit 10 and the dynamic update unit 11 in the learning device 1 are implemented by a processing circuit. That is, the learning device 1 includes a processing circuit for performing processes of steps ST1 to ST5 in FIG. 11 which will be described later. The processing circuit may be dedicated hardware or a central processing unit (CPU) for executing a program stored in a memory.

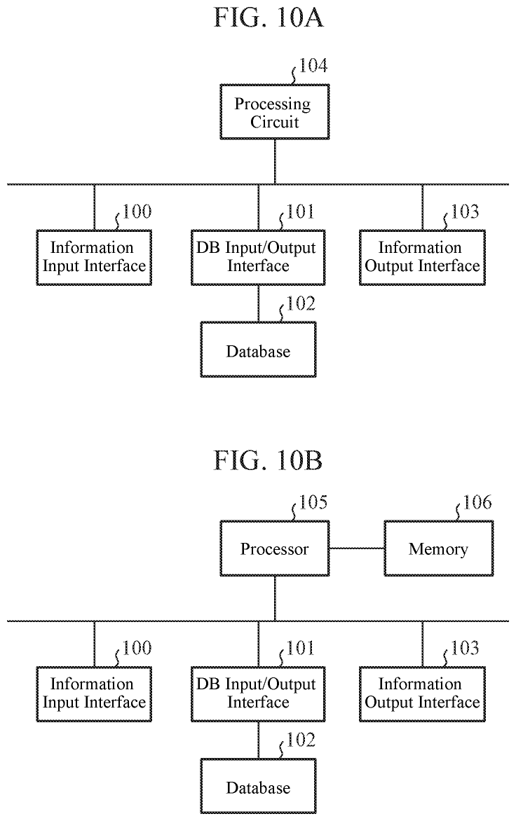

FIG. 10A is a block diagram illustrating a hardware configuration for implementing the functions of the learning device 1. FIG. 10B is a block diagram illustrating a hardware configuration for executing software for implementing the functions of the learning device 1. In 10A and 10B, an information input interface 100 relays input of information from an external device (not illustrated) to the learning device 1 illustrated in FIGS. 1 and 2. For example, the neural network managing unit 10c illustrated in FIG. 2 inputs neural network initial parameters from an external device via the information input interface 100. The external device may be a storage device provided independently of the learning device 1. For example, the learning device 1 may use a storage device on a cloud network.

ADB input/output interface 101 relays data exchange between the learning device 1 and a database 102. The database 102 corresponds to the learning data DB 2 and the NG determination group DB 3 illustrated in FIGS. 1 and 2. For example, the learning reference label generating unit 10b included in the learning unit 10 inputs data from the learning data DB 2 and the NG determination group DB 3 via the DB input/output interface 101. Note that the database 102 may be configured in a storage device provided independently of the learning device 1. For example, the learning device 1 inputs data from the database 102 configured in a storage device on a cloud network via the DB input/output interface 101.

The learning reference label buffer 10a, the NG index value buffer 10e, the history buffer 11a, and the NG candidate buffer 11b illustrated in FIG. 2 are configured in a memory incorporated in a processing circuit 104 illustrated in FIG. 10A or in a memory 106 illustrated in FIG. 10B. An information output interface 103 relays information output from the learning device 1 to an external device (not illustrated). For example, the neural network updating unit 10d illustrated in FIG. 2 outputs neural network parameters to the external device via the information output interface 103. The external device may be, for example, an abnormality detection device that uses a classifier provided by the neural network parameters.

In a case where the processing circuit is the processing circuit 104 of dedicated hardware illustrated in FIG. 10A, the processing circuit 104 may be, for example, a single circuit, a composite circuit, a programmed processor, a parallel programmed processor, an application specific integrated circuit (ASIC), a field-programmable gate array (FPGA), or a combination thereof. The functions of the learning unit 10 and the dynamic update unit 11 in the learning device 1 may be implemented by separate processing circuits, or these functions may be collectively implemented by a single processing circuit.

In the case where the processing circuit is the processor 105 illustrated in FIG. 10B, the functions of the learning unit 10 and the dynamic update unit 11 in the learning device 1 are implemented by software, firmware, or a combination of software and firmware. Note that the software or the firmware is described as a program and is stored in the memory 106.

The processor 105 reads and executes the program stored in the memory 106 and thereby implements functions of the learning unit 10 and the dynamic update unit 11 in the learning device 1.

That is, the learning device 1 includes the memory 106 for storing programs execution of which by the processor 105 results in execution of processes of steps ST1 to ST5 illustrated in FIG. 11. These programs cause a computer to execute the procedure or method of the learning unit 10 and the dynamic update unit 11. The memory 106 may be a computer-readable storage medium storing the programs for causing a computer to function as the learning unit 10 and the dynamic update unit 11.

The memory 106 corresponds to a nonvolatile or volatile semiconductor memory such as a random access memory (RAM), a read only memory (ROM), a flash memory, an erasable programmable read only memory (EPROM), or an electrically-EPROM (EEPROM), a magnetic disc, a flexible disc, an optical disc, a compact disc, a mini disc, a DVD, or the like.

Some of the functions of the learning unit 10 and the dynamic update unit 11 may be implemented by dedicated hardware, and some thereof may be implemented by software or firmware. For example, the learning unit 10 implements functions thereof using a processing circuit that is dedicated hardware, whereas the dynamic update unit 11 implements functions thereof by causing the processor 105 to read and execute programs stored in the memory 106. In this manner, the processing circuit can implement the functions described above by hardware, software, firmware, or a combination thereof.

Next, the operation will be described.

FIG. 11 is a flowchart illustrating a learning method according to the first embodiment.

In step ST1, the learning reference label generating unit 10b sets value 0 to the OK flag corresponding to an element belonging to the NG determination group and sets value 1 to the NG flag corresponding thereto, among the multiple elements of the learning data, and thereby generates a learning reference label for each of the elements of the learning data. Moreover, the neural network managing unit 10c configures an initial state neural network using the neural network initial parameters.

In step ST2, the neural network managing unit 10c inputs the elements of the learning data to the neural network, and calculates an NG index value for each of the elements on the basis of the output result of the neural network. Next, the neural network managing unit 10c determines whether a target element belongs to the OK class or the NG class on the basis of the NG index value. Subsequently, the neural network managing unit 10c performs error evaluation on the initial value of the learning reference label corresponding to the target element and the learning reference label updated by the dynamic update unit 11, and the determined class, by using an error function. A function described in Reference Literature 1 may be used as the error function. Furthermore, the history managing unit 11c stores the NG index values obtained each time the learning is repeated in the history buffer 11a.

In step ST3, the test unit 11d evaluates whether an NG candidate element is to be confirmed to be OK or NG, on the basis of the result of statistically testing the change trend of the NG index values stored in the history buffer 11a. The learning reference label updating unit 11 e updates the learning reference label on the basis of the evaluation result by the test unit 11d. For example, the learning reference label updating unit 11 e updates the learning reference label corresponding to an element confirmed to be OK by the test unit 11d, from an NG label to an OK label.

In step ST4, the neural network updating unit 10d updates neural network parameters on the basis of the NG index value obtained by the neural network managing unit 10c. The series of learning processes from step ST2 to step ST4 is repetitively performed for each of the multiple elements included in the learning data.

When the learning repetition is completed, the neural network updating unit 10d outputs the neural network parameters updated by the above-described series of learning, as a learning result (step ST5).

Next, a learning reference label generating process will be described in detail.

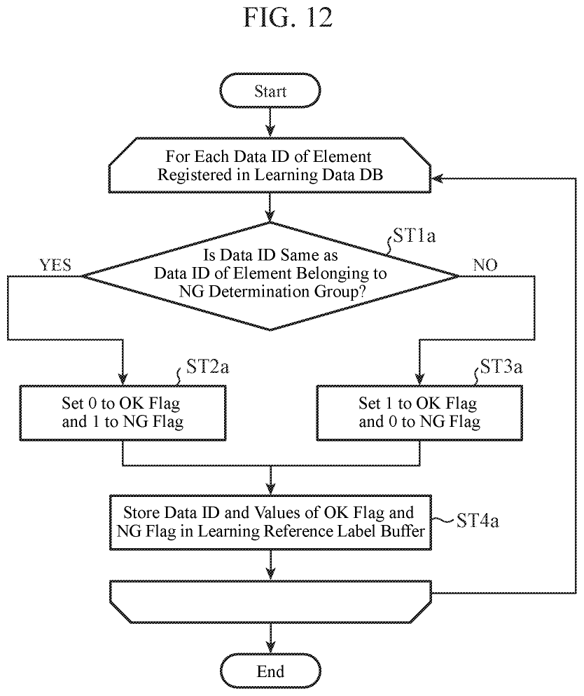

FIG. 12 is a flowchart illustrating the learning reference label generating process, and illustrates a process for generating initial values of the learning reference label.

The learning reference label generating unit 10b sequentially reads a data ID of each element of the learning data registered in the learning data DB 2 and executes the following processes.

The learning reference label generating unit 10b determines whether or not, among the data IDs of the elements read from the learning data DB 2, there is a data ID same as a data ID of an element belonging to the NG determination group registered in the NG determination group DB 3 (step ST1a).

If it is determined that the data ID of a target element is the same as a data ID of an element belonging to the NG determination group (step ST1a: YES), the learning reference label generating unit 10b sets value 0 to the OK flag corresponding to the target element and value 1 to the NG flag corresponding thereto (step ST2a). On the other hand, if it is determined that the data ID of a target element is different from the data IDs of the elements belonging to the NG determination group (step ST1a: NO), the learning reference label generating unit 10b sets value 1 to the OK flag corresponding to the target element and value 0 to the NG flag corresponding thereto (step ST3a).

Having set values in the OK flag and the NG flag corresponding to the target element, the learning reference label generating unit 10b stores the data ID and the values of the OK flag and the NG flag of the target element in the learning reference label buffer 10a (step ST4a).

The learning reference label generating unit 10b repeatedly executes the series of processes from step ST1a to step ST4a for all the elements of the learning data registered in the learning data DB 2. By the processes, initial values of the learning reference labels are generated.

Next, a neural network managing process will be described in detail.

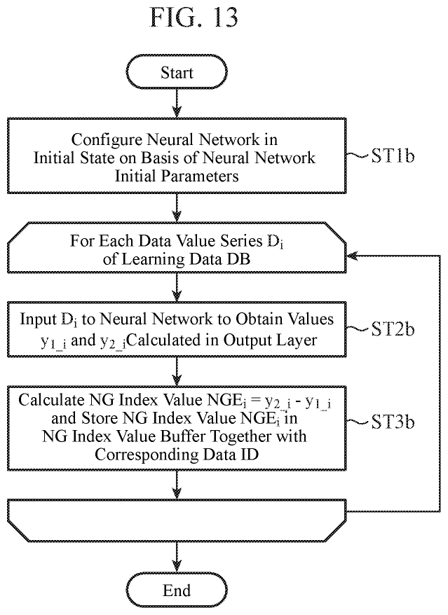

FIG. 13 is a flowchart illustrating the neural network managing process, and illustrates a process of calculating an NG index value for each element.

In the initial process, the neural network managing unit 10c configures an initial state neural network on the basis of the neural network initial parameters (step ST1b).

Next, the neural network managing unit 10c inputs the elements of the learning data read from the learning data DB 2 (data value series Dᵢ) to the neural network, and obtains output values y_{1_i} and y_{2_i} calculated in the output layer (step ST2b). As described above, the output value y_{1_i} represents the degree to which the element belongs to the OK class, and the output value y_{2_i} indicates the degree to which the element belongs to the NG class. An element (data value series Dᵢ) input to the neural network is determined to belong to the OK class when y_{1_i}>y_{2_i} holds, and is determined to belong to the NG class when y_{1_i}≤y_{2_i} holds. The neural network managing unit 10c performs error evaluation on the determined class and the learning reference label.

In step ST3b, the neural network managing unit 10c calculates y_{2_i}−y_{1_i} as an NG index value NGE and stores the calculated NG index value NGE in the NG index value buffer 10e together with the data ID of the corresponding element.

Note that although y_{2_i}−y_{1_i} is used as NGE, the ratio of y_{1_i} and y_{2_i} may be used as NGE, or a distance considering the distribution of y_{1_i} and y_{2_i} may be used as NGEᵢ.

The neural network managing unit 10c repeatedly executes the series of processes from step ST2b to step ST3b for all the elements of the learning data registered in the learning data DB 2.

Next, a history managing process of NG index values will be described in detail.

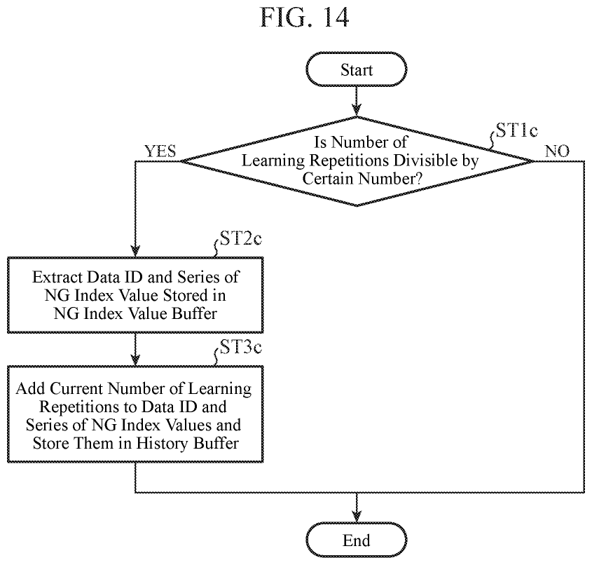

FIG. 14 is a flowchart illustrating the history managing process of NG index values.

First, the history managing unit 11c determines whether or not the number of learning repetitions is divisible by a certain number (for example, 100) (step ST1c). The number of learning repetitions is the number of times that the series of processes by the learning unit 10 from step ST2 to step ST4 illustrated in FIG. 11 is repetitively performed.

If it is determined that the number of learning repetitions is divisible by a certain number (step ST1c: YES), the history managing unit 11c extracts a data ID and a series of NG index values of elements corresponding to the data ID from the NG index value buffer 10e (step ST2c).

Next, the history managing unit 11c adds the current number of learning repetitions to the extracted data ID and the series of NG index values and stores them in the history buffer 11a (step ST3c).

Then the history managing unit 11c terminates the process of FIG. 14 and proceeds to the process of the test unit 11d.

On the other hand, if it is determined that the number of learning repetitions is not divisible by a certain number (step ST1c: NO), the history managing unit 11c terminates the process of FIG. 14, and proceeds to the process of the neural network updating unit 10d.

Next, a statistical test process of NG index values will be described in detail.

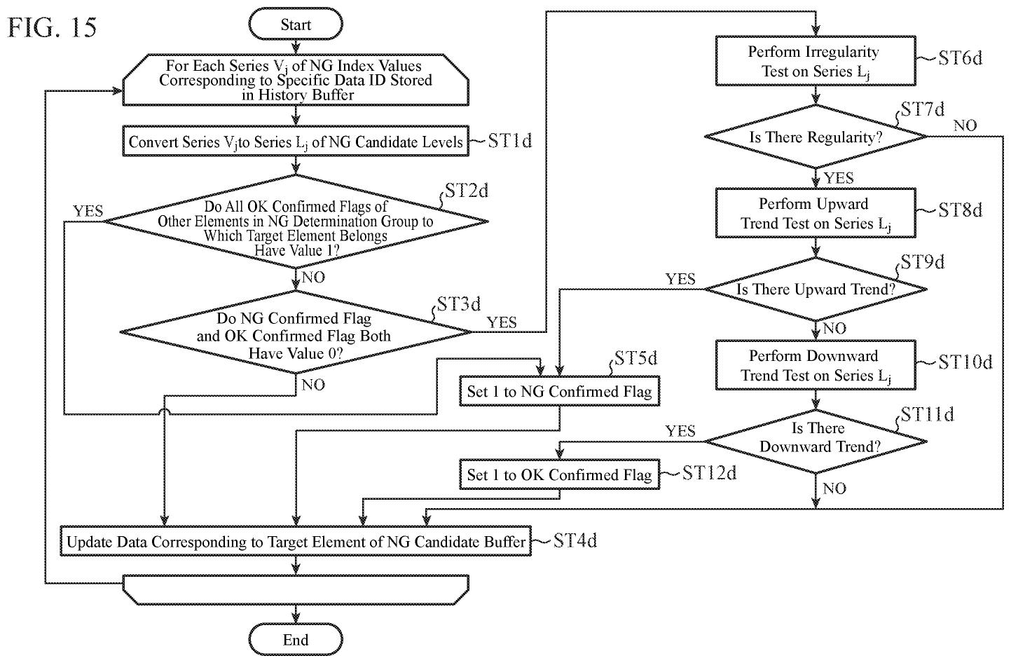

FIG. 15 is a flowchart illustrating a statistical test process of NG index values.

The test unit 11d extracts, from the history buffer 11a, a series Vⱼ of NG index values for each number of learning repetitions that correspond to the data ID of a j-th element (target element), and converts the extracted series Vⱼ of NG index values to a series Lⱼ of NG candidate levels (step ST1d). The series Lⱼ is determined by what number of a range, obtained by equally dividing the range of the past values of the series Vⱼ by a certain number, the current NG index value belongs to.

For example in a case where the range of past values of the series Vⱼ of NG index values is equally divided into five ranges, NG candidate levels are assigned as −2, −1, 0, +1, and +2 as illustrated in FIG. 9.

NG candidate level 0 corresponds to the middle range of the past NG index values. NG candidate level +1 corresponds to a range where the NG index value is larger than in the middle range, and NG candidate level +2 corresponds to a range where the NG index value is larger than in the range corresponding to NG candidate level +1. NG candidate level −1 corresponds to a range where the NG index value is smaller than in the middle range, and NG candidate level −2 corresponds to a range where the NG index value is smaller than in the range corresponding to NG candidate level −1.

Note that initially there is only one NG index value, and thus the range of past values of the series Vⱼ is 0. The NG candidate level at this point is set to 0.

The test unit 11d determines whether or not value 1 is set in the OK confirmed flags corresponding to all elements other than the target element, among the elements belonging to the NG determination group to which the target element (NG candidate) belongs (step ST2d). At this point, if value 0 is set in the OK confirmed flag corresponding to any one of the elements (step ST2d: NO), the test unit 11d refers to the NG candidate buffer 11b and confirms whether or not value 0 is set in both the NG confirmed flag and the OK confirmed flag corresponding to the target element (step ST3d).

If value 1 is set in the NG confirmed flag or the OK confirmed flag (step ST3d: NO), the test unit 11d updates the data corresponding to the target element in the NG candidate buffer 11b with the current number of learning repetitions, the current NG candidate level of the target element, and the values of the current OK confirmed flag and NG confirmed flag of the target element (step ST4d).

Then, the test unit 11d continues to extract a series Vⱼ₊₁ of NG index values corresponding to the data ID of the (j+1)th element from the history buffer 11a, and repeats the processes from step ST1d.

Of the elements belonging to the NG determination group to which the target element belongs, if value 1 is set in OK confirmed flags corresponding to all elements other than the target element (step ST2d: YES), the test unit 11d determines the value to be set in the NG confirmed flag corresponding to the target element, to be “1” (step ST5d). Then, the test unit 11d proceeds to the process of step ST4d and sets value 1 to the NG confirmed flag corresponding to the target element in the NG candidate buffer 11b to be updated.

If value 0 is set in both the NG confirmed flag and the OK confirmed flag corresponding to the target element (step ST3d: YES), the test unit 11d performs an irregularity test based on a certain reliability coefficient (for example, 0.95) on the series Lⱼ of NG candidate levels (step ST6d). The test unit 11d determines whether or not the series Lⱼ of NG candidate levels has regularity, on the basis of the result of the irregularity test on the series Lⱼ of NG candidate levels (step ST7d).

If regularity is not confirmed in the series Lⱼ of NG candidate levels, and it is determined that the change trend of the NG index values randomly changes each time learning is repeated (step ST7d: NO), the test unit 11d does not confirm the target element to be OK nor NG. Thereafter, the test unit 11d proceeds to the process of step ST4d.

If it is determined that the change trend of the NG index values is regular for each repetition of learning after regularity is confirmed in the series Lⱼ of NG candidate levels (step ST7d: YES), the test unit 11d performs an upward trend test on the series Lⱼ of NG candidate levels (step ST8d). The test unit 11d determines whether or not the series Lⱼ of NG candidate levels has an upward trend, on the basis of the result of the trend test on the series Lⱼ of NG candidate levels (step ST9d).

If the series Lⱼ of NG candidate levels has an upward trend (step ST9d: YES), the test unit 11d determines that the NG index value increases each time learning is repeated, and proceeds to the process of step ST5d. As a result, a value to be set in the NG confirmed flag corresponding to the target element is determined to be “1”, and NG is confirmed.

On the other hand, if no upward trend is confirmed in the series Lⱼ of NG candidate levels (step ST9d: NO), the test unit 11d performs a downward trend test on the series Lⱼ of NG candidate levels (step ST10d). The test unit 11d determines whether or not the series Lⱼ of NG candidate levels has a downward trend, on the basis of the result of the trend test on the series Lⱼ of NG candidate levels (step ST11d).

If no downward trend is confirmed in the series Lⱼ of NG candidate levels (step ST11d: NO), the test unit 11d proceeds to the process of step ST4d and determines the value of the series Lⱼ to be the current NG candidate level, which is caused to be reflected in the NG candidate buffer 11b.

When a downward trend is confirmed in the series Lⱼ of NG candidate levels (step ST11d: YES), the test unit 11d determines that the NG index value becomes smaller each time learning is repeated, and determines a value to be set in the OK confirmed flag corresponding to the target element to be “1” (step ST12d). Then, the test unit 11d proceeds to the process of step ST4d and sets value 1 to the OK confirmed flag corresponding to the target element in the NG candidate buffer 11b to be updated.

Next, a learning reference label updating process will be described in detail.

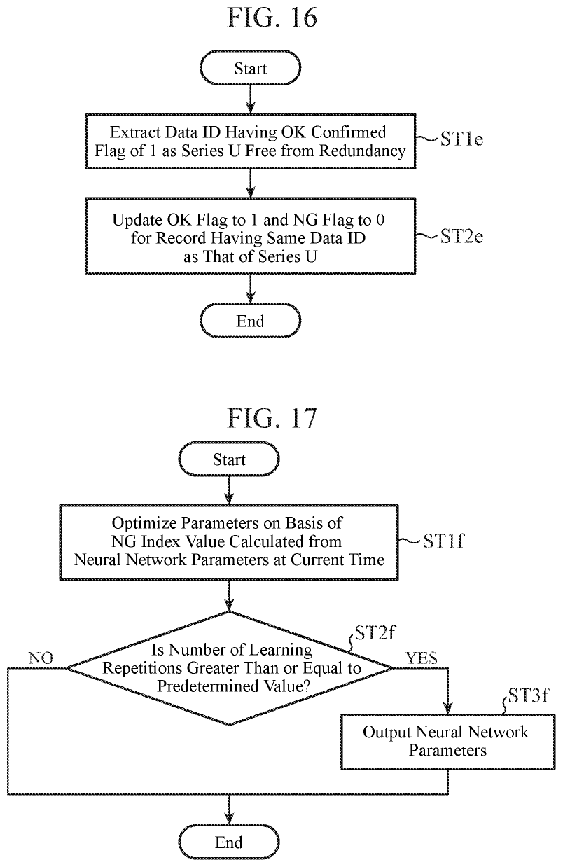

FIG. 16 is a flowchart illustrating the learning reference label updating process.

The learning reference label updating unit 11e extracts, from the NG candidate buffer 11b, a data ID of an element having the OK confirmed flag set to value 1, as a series U free from redundancy (step ST1e). The series U includes the data ID of the element having the OK confirmed flag set to value 1.

Next, the learning reference label updating unit 11e specifies a record having the same data ID as the data ID included in the series U in the learning reference label buffer 10a, and updates the learning reference label so that the OK flag has value 1 and the NG flag has value 0 for the specified record (step ST2e). Since this process is executed during the learning of the neural network by the learning unit 10, the learning reference label is dynamically updated.

Next, a neural network parameter updating process will be described in detail.

FIG. 17 is a flowchart illustrating the neural network parameter updating process.

The neural network updating unit 10d extracts, from the NG index value buffer 10e, an NG index value calculated from the output result of the neural network configured by the current neural network parameters by the neural network managing unit 10c.

On the basis of the NG index value extracted from the NG index value buffer 10e, the neural network updating unit 10d optimizes the neural network parameters (step ST1f). For example, on the basis of the NG index value extracted from the NG index value buffer 10e, the neural network updating unit 10d optimizes the current neural network parameters using the gradient descent optimization method described in Reference Literature 1. This optimization is performed sequentially each time learning is repeated.

Subsequently, the neural network updating unit 10d determines whether or not the number of learning repetitions has reached or exceeded a predetermined value (for example, 10000) (step ST2f).

If the number of learning repetitions is less than the predetermined value (step ST2f: NO), the neural network updating unit 10d terminates the process in FIG. 17 and proceeds to the process from the step ST2 in FIG. 11 by the neural network managing unit 10c.

On the other hand, if the number of learning repetitions is greater than or equal to the predetermined value (step ST2f: YES), the neural network updating unit 10d outputs the neural network parameters at that time, as a learning result (step ST3f). The neural network configured using the neural network parameters of the learning result functions as a classifier that determines at least one piece of the data belonging to the NG determination group to be NG.

Next, a classifier obtained by the learning device 1 according to the first embodiment will be described.

Here, let us consider a situation where there is a history that a group (group of cases) has been determined to be NG as a whole; however, it is unknown which element in the group is NG, for example, a situation where there are three groups of which two groups each have been determined to be NG as a whole and the remaining one group has been determined to be OK as a whole. One of the groups determined to be NG is defined as an NG determination group (1) {E11 (OK), E12 (G), E13 (OK)}, and the other is determined as an NG determination group (2) {E21 (G), E22 (OK), E23 (OK)}. The group determined to be OK is defined as an OK determination group (3) {E31 (OK), E32 (OK), E33 (OK)}.

In the NG determination group (1), only the second element is NG, and the remaining elements are OK. Meanwhile in the NG determination group (2), only the first element is NG, and the remaining elements are OK. However, since these groups include NG elements, each of the groups is determined to be NG as a whole. Although OK or NG for each element is illustrated inside parentheses of the corresponding element E, OK and NG for each element is unknown at a stage in which the three groups are handled as learning data.

Only the determination result of OK or NG for the entire group is known at the learning stage of the classifier. Therefore, when each of the elements is classified as OK or NG, all of the six elements E11 (OK), E12 (G), E13 (OK), E21 (G), E22 (OK), and E23 (OK) are regarded as NG and thereby learned at the learning stage of the classifier. That is, four of these elements are incorrectly learned as NG despite the fact that the elements are originally OK. As a result, the classification accuracy of the classifier as the learning result is deteriorated.

For example in a case where OK or NG is determined for group (4) {E41 (OK), E42 (OK), E43 (OK)} and group (5) {E51 (OK), E52 (OK), E53 (G)}, an element that is originally OK is incorrectly learned as NG in a conventional classifier, and thus there is a possibility that any one of the elements belonging to group (4) is determined as NG. If any one of the elements belonging to group (4) is determined to be NG, disadvantageously, the entire group (4) is also determined to be NG. As described above, conventional classifiers have low classification accuracy for each element and low classification accuracy for each group.

Meanwhile, in the learning device 1 according to the first embodiment, a learning reference label, obtained by assigning an OK label or an NG label to each element, is updated on the basis of a result of a statistical test on the change trend of NG index values. As a result, it is rare for the learning unit 10 to incorrectly learn an element that is originally OK as NG, and thus the learning unit 10 can learn a classifier that performs highly accurate classification.

In addition, since the classifier as the learning result determines at least one piece of data belonging to the NG determination group to be NG, if group (5) is an NG determination group, group (5) is appropriately determined to be NG, whereas group (4) is determined to be OK.

As described above, the learning device 1 according to the first embodiment includes the learning unit 10 and the dynamic update unit 11. The learning unit 10 learns a neural network by inputting the multiple elements of the learning data and using a learning reference label, and thereby outputs a classifier for determining at least one piece of the data belonging to the group to be NG using the neural network as the learning result. The dynamic update unit 11 dynamically updates the learning reference label while the learning unit 10 learns the neural network. In this configuration, the learning unit 10 repetitively learns the neural network by sequentially using the learning reference label updated from the initial value of the learning reference label by the dynamic update unit 11, and calculates an NG index value corresponding to an element of the learning data using an output value of the neural network for each repetition of learning. The dynamic update unit 11 updates the learning reference label on the basis of a result obtained by statistically testing a change trend of the NG index value obtained for each transition of the number of learning repetitions. Since the classifier as the learning result determines that at least one piece of the data belonging to the group is NG, the learning device 1 can provide a classifier that performs highly accurate classification.

Note that the present invention is not limited to the above embodiment, and a modification of any component of the embodiment, or omission of any component in the embodiment may be adopted within the scope of the present invention.

### INDUS TRIAL APPLICABILITY

A learning device according to the present invention can provide a classifier that performs highly accurate classification, and thus can be used in, for example, an abnormality detection system.

### REFERENCE SIGNS LIST

1: learning device, 2: learning data DB, 3: NG determination group DB, 10: learning unit, 10a: learning reference label buffer, 10b: learning reference label generating unit, 10c: neural network managing unit, 10d: neural network updating unit, 10e: NG index value buffer, 11: dynamic update unit, 11a: history buffer, 11b: NG candidate buffer, 11c: history managing unit, 11d: test unit, 11e: learning reference label updating unit, 100: information input interface, 101: DB input/output interface, 102: database, 103: information output interface, 104: processing circuit, 105: processor, 106: memory

1. A learning device comprising:
processing circuitry
to input learning data including multiple elements and group information in which it is defined that at least one piece of data belonging to a group is determined to be NG, and learn a neural network by inputting the multiple elements of the learning data and using a learning reference label assigned with an OK label or an NG label for each of the elements of the learning data, thereby output a classifier to determine the at least one piece of data belonging to the group to be NG using the neural network which is a result of the learning; and
to dynamically update the learning reference label during learning of the neural network,
wherein the processing circuitry:
generates an initial value of the learning reference label for each of the elements of the learning data by using the learning data and the group information;
repetitively learns the neural network, by sequentially using the learning reference label updated from the initial value of the learning reference label; and
calculates an NG index value with which each of the elements of the learning data can be NG, by using an output value of the neural network for each repetition of learning, and
the processing circuitry updates the learning reference label, on a basis of a result obtained by statistically testing a change trend of the NG index value obtained for each transition of the number of learning repetitions.

2. The learning device according to claim 1,
wherein the processing circuitry:
stores the learning reference label for each of the elements of the learning data;
generates an initial value of the learning reference label, the initial value being obtained by, in a case where each of the elements of the learning data does not belong to the group, assigning an OK label to a corresponding one of the elements, and in a case where each of the elements belongs to the group, assigning an NG label to a corresponding one of the elements;
calculates the NG index value of each of the elements of the learning data using an output value of the neural network, determines, out of an OK class and an NG class, a class to which each of the elements of the learning data belongs on a basis of the NG index value, and performs an error evaluation on the initial value of the learning reference label, the updated learning reference label, and the determined class; and
updates neural network parameters on a basis of the calculated NG index value.

3. The learning device according to claim 1,
wherein the processing circuitry:
stores the NG index value obtained for each number of learning repetitions;
stores, for each of the elements of the learning data, the number of learning repetitions, an NG candidate level corresponding to the NG index value, an OK confirmed flag indicating that a corresponding one of the elements of the learning data is confirmed to be OK, and an NG confirmed flag indicating that a corresponding one of the elements of the learning data is confirmed to be NG;
stores the NG index value obtained for each repetition of learning;
statistically tests a change trend of the stored NG index value by using transition of the NG candidate level, confirms OK or NG on one or more NG candidate elements of the elements on a basis of a result of the test, and updates the OK confirmed flag or the NG confirmed flag corresponding to each of the NG candidate elements; and
updates, from an NG label to an OK label, the learning reference label corresponding to an element confirmed to be OK, out of the NG candidate elements.

4. A learning method comprising:
inputting learning data including multiple elements and group information in which it is defined that at least one piece of data belonging to a group is determined to be NG, and learning a neural network by inputting the multiple elements of the learning data and using a learning reference label assigned with an OK label or an NG label for each of the elements of the learning data, thereby outputting a classifier to determine the at least one piece of data belonging to the group to be NG using the neural network which is a result of the learning; and
dynamically updating the learning reference label during learning of the neural network,
wherein the method includes:
generating an initial value of the learning reference label for each of the elements of the learning data by using the learning data and the group information;
repetitively learning the neural network, by sequentially using the learning reference label updated from the initial value of the learning reference label; and
calculating an NG index value with which each of the elements of the learning data can be NG, by using an output value of the neural network for each repetition of learning, and
updating the learning reference label, on a basis of a result obtained by statistically testing a change trend of the NG index value obtained for each transition of the number of learning repetitions.
